(19) United States
(12) Patent Application Publication
(10) Pub. No.: US 2025/0181470 A1
(43) Pub. Date: Jun. 5, 2025

(54) Cloud Instantiation Based on Machine Learned Prediction

(71) Applicant: Tangoe US, Inc., Stamford, CT (US)

(72) Inventors: Paolo Sellari, Shelton, CT (US); Dawn Michele Preston, Cleveland, GA (US); Jaan Leemet, Aventura, FL (US)

(21) Appl. No.: 18/964,975

(22) Filed: Dec. 2, 2024

Related U.S. Application Data
(60) Provisional application No. 63/606,289, filed on Dec. 5, 2023.

(51) Int. Cl. G06F 11/30; G06F 11/34

(52) U.S. Cl. CPC G06F 11/3072; G06F 11/3051; G06F 11/3438

(57) ABSTRACT

A system is provided for instantiating cloud services for an application in real time to allow the application to run in a small footprint and only request additional services on demand. By using predictive algorithms to forecast which services a user may want to access and having the resources available for them when the service is required the system is able to also improve response time for these on-demand services. The software can use and request/reserve resources from different IaaS providers based on computing needs and costs and an appropriate balance between the two.

### FIELD OF THE INVENTION

The present invention relates to systems and methods for predicting resource needs for cloud applications. More specifically the system anticipates, acquires, and instantiates cloud services from mixed providers to cater to the needs of a given application in real time or near real time as users are navigating in the application.

### BACKGROUND OF THE INVENTION

Cloud services and running applications in the cloud has become mainstream for many organizations. There are a multitude of providers offering cloud services, usually at different prices and pricing models, many of which are dynamic.

While capability wise, most hosting providers are similar in that their underlying services have become commoditized, there are differences in pricing models and how individual resources are priced and made available. Depending on the characteristics of a given application and the predicted resource needs, a determination can be made about which provider can be the best fit both cost wise and capability wise.

As many service providers offer dynamic pricing for their services, dynamically shopping around for a provider to run jobs on demand can be beneficial. While mainstream pricing may apply during business hours when applications are most active, preferential pricing may be available and lower priority batch jobs that are not immediately needed can benefit from these reduced pricing windows. This can also be true for real-time demands when users are logged in at off-peak hours.

The spinning up and down of whole instances has become an effective way of running jobs without reserving and provisioning long term dedicated hardware. This practice has been primarily used for larger jobs such as long power-hungry number crunching intensive ones. Some examples would include: loading and parsing large files or datasets and performing data transformations.

The overall goal being to reduce the application footprint and resultant operational cost while only asking for resources when they are needed and, in this case, predicted to be needed. The savings of only having the resources available for short periods of time when requested lowers cost and improves response time over traditional models of provisioning.

Much of the job selection criteria for this dynamic loading has been based on the time involved in spinning up these instances. While the provisioning services to instantiate cloud services in an automated fashion has evolved and become simpler and faster, it is still not fast enough to accommodate real time needs introducing unwanted delays and lag in the application which would be perceived by the users. When a user presses a button to get a report or get to the next menu screen, the delay from spinning up a service adds sufficient delay that the lag time in unacceptable in terms of the end user experience.

Any notion of shopping around to find the best service provider offering real-time dynamic pricing and then spinning that up and setting up the data connections would add further delays to the process.

U.S. Pat. No. 11,134,013 titled provides a multi-cloud bursting service which generates cloud agnostic burst templates for bursting workload environments on different clouds, each of the cloud agnostic burst templates defining a stack for a workload environment and tasks for provisioning cloud resources and deploying, on the cloud resources, the workload environment associated with the stack, the stack including applications, libraries, services, data, and/or an operating system. However, there is no notion of predicting or using machine learned factors in the provisioning. Thus, the system described would not work for sudden demands or short queues of large tasks as the provisioning time will introduce delays when no prediction is used in these cases.

U.S. Pat. No. 7,490,325 describes managing job submissions in a compute environment such as a cluster and more specifically to intelligent data just in time data pre-staging to optimize the use of diverse compute resources. Jackson does not describe learning features and specifically does not describe a learned capability of measuring actual historical data nor does it use machine learning to predict users next steps within the application.

EP2894564 to Fujitsu describes collecting historical job data related to job submissions received from a plurality of users and calculating a believability score for each of the plurality of users based on a comparison between the job resource request data and the resource usage data related to one or more job submissions received from the user, the believability score indicating a degree to which the user overestimates resources required to execute jobs. The believability score and any adjustments to computing power/reservations is related to knowledge of the application being run in the environment or the user's interaction with that application.

U.S. Pat. No. 11,665,107 provides an on-demand service broker which provisions IaaS resources at service instance creating time. The service broker provides a catalog listing one or more service plans, each service plan corresponds to a set of available resources. A user device selects a respective service plan that matches specific needs of an application that consumes the resources. These resources are scheduled and deployed on demand based on a selected need for an application. The needs are not predicted or forecasted and may thus cause deployment delays.

U.S. Pat. No. 10,937,036 enables a user to dynamically perform various ‘what-if’ analysis to determine optimum purchase times, and configurations. Wasser does not teach getting the resources in real time from a single user in an application, nor does Wasser teach combining resource needs from multiple users on a system to make an aggregate demand for resources in real time.

Therefore, a need exists for a system and method to track user behavior, create a model for predicting user actions, and pre-allocate resources for a pool of users so that these are available in real time as the users need them.

### SUMMARY OF THE INVENTION

Accordingly, it is desired to provide a system and method that runs an application in a minimal footprint at reduced cost and allocates and obtains resources for users when they need them.

While many systems running batches of jobs can benefit from the above inventions, these are not applicable to systems that dynamically create resources and run jobs when the user is live in the app and the user experience may be affected if the system is forced to wait for the resources to be provisioned.

To minimize or eliminate delays, it would be beneficial to have a predictive capability for resource planning and instantiation which can provide computing resources availability with reduced lag or delay in the applications where user response times are key. This pre-instantiation can reduce the footprint of applications requiring SLA conformance by having a much smaller base level provisioned system as there is no need to create and manage large queues of jobs. Thus, it is possible to forecast immediate demand and make appropriate resources available.

Thus, a system that could predict demands and have resource ready to run would provide a much better user experience and would benefit from a less costly base environment in the cloud to run applications. If a system can track and predict individual user's actions within an application and then cater to these (or batches of these) in real time to offset the cost of having to always have resources available to accommodate such a load, it would be very beneficial to saving cost while maintaining a good level of performance and responsiveness.

Accordingly, it would be beneficial to have a system that can predict a user's resource needs within an application with a confidence factor so as to launch and pre-provision resources to improve response time and reduce overall footprint when these resources are not needed.

It would further be beneficial to have such a system apply machine learning to better predict the users resource needs and to adapt to such needs over time based on historical data as well as external data such as HR data and trend data.

It would further be beneficial to have a system that would allow combining overall application needs based on the predicted behavior or multiple users to launch and pre-provision resources.

It would still further be beneficial to have a system that would decommission excess resources when users are on the system to keep the resource pool right sized.

It is also desired to provide a system and method that is able to predict users' actions within the application and the associated resources that would be needed to satisfy those actions.

It is still further desired to provide a system and method that can learn from the user's behavior and the changing dynamics of the applications and the data set with regards to resource utilization and apply this knowledge to the resource predictions.

It is still further desired to provide a system that can aggregate user resource requirements across multiple users and obtain and pre-provision the resources needed dynamically in near-real time and so as not to adversely affect the user experience by introducing delays.

The present invention looks to predict a user's next steps and obtains resources from one or more providers in anticipation of a user's actions. For example, as a user is moving towards a report area, the system uses machine learning to predict what resources may be needed based on knowing the users job function, knowing which reports he or she regularly runs, and knowing the size of the data set will be needed to produce the report. The application predicts the user's trajectory in the application with a set of weighted confidence factors from historical behavior learned through machine intelligence. Additional data such as the user's role in the organization, the date and time, and more are also used to predict patterns and common functions. For example, if a time management program is run every Friday afternoon, and the user is logged in on a Friday and navigating towards this part of the application, the confidence that this function will be run is predictable with a high degree of confidence and resources can be allocated for this purpose.

In one configuration the system can utilize generic job profiles capable of running a multitude of jobs that are started which can be dynamically adapted or extended for specific job needs once more specific job functions are determined. For example, as a user approaches a reporting menu area, there may be a generic report handling functional profile that is capable of running multiple report types. The appropriate computing resources can be spun up in anticipation of one of the many report buttons being pressed in the near future. This allows the system to get a head start with provisioning even when the exact report type is not known. The system performs the setting up of resources and data connections thus reducing any delays in the user experience.

The cost of creating dynamic instances in real time is low enough that even if the system makes a wrong prediction and the user retreats from the report area or gets delayed/distracted resulting in no report function being called, the system can wind down the computing resources that were spun up without having used a lot of resources. The cost of the instance in itself is minimal, and if no report is run, the amount of memory, bandwidth, CPU used is minimal. As a result, the cost of spinning up the resources in anticipation of usage is relatively low as the features such as memory, bandwidth and CPU that are charged for are minimal. In some cases, other users on the system may require resources, and the unused instance can be reutilized for another user. The system can therefore monitor the patterns of multiple users at any given time and coordinate spinning up resources accordingly based on a predicted likelihood of how many of those users will actually use resources.

In another configuration, the system anticipates multiple users requiring instances with a certain usage profile. Take for example a department that is running the same or similar reports on a Friday. The system may keep one such job profile running in anticipation of others needing it on short order. Pricing for services may be such that the instantiation and running of a single longer job or two or more similar jobs is lower than the immediate provisioning and decommissioning of each job instance individually. In such cases, a timeout flag is left on the resource profile and a housekeeping function is used to clear and decommission unused jobs which remain idle beyond a certain threshold time.

Since the instance can be spun down with little to no resources used, and the cost is minimal, the cost savings of instantiating the services on demand saves money overall as compared to having the resources always available, even with a number of false positives.

Machine learning is employed to find patterns in user behavior such as running certain functions on a weekly or monthly basis. As an example, users may all run their to-do lists on Monday morning and enter their timesheets on Friday afternoon. The sales department may always run the same sales reports on a weekly basis. In addition to predicting these events, the system also has a capability of asking the user if he/she would like the reports to be generated automatically at a given time. This allows for even more savings as the system can shop for the best time with more flexibility for selecting the time to run the reports and fire up the instance to do this during off-peak hours.

If warranted, and the user demands are high, the system may decide to allocate a number of tasks or a larger task for a longer, or even an indefinite period to accommodate the evolving needs of the system. The machine learning part of the system weights the costs and the needs to achieve the appropriate balance of which resources to deploy full time and which to spin up on demand. As a simple example, if the number of users had doubled and a night shift has been added, it is possible that there is a constant need for some jobs to be made available. Conversely, if the company goes to a 4-day work week, there may be less demand for these tasks on a full-time basis and it may be more cost effective to spin them up on demand. These are but some examples should not be construed as limiting. Access to the resource needs and the pricing dynamically gives the system the data to make intelligent and informed decisions on how to allocate the resources in the most cost-effective fashion. The current mix may even change as prices vary, and the system monitors these aspects continually, adjusting as necessary.

These and other objects are achieved by providing a system for instantiating cloud services in an infrastructure as a service (IaaS) environment comprising software executing on a computer, the software is in communication with a software application accessible to a user, the software determines one or more predicted actions of the user within said software application and activates and/or deactivates computing resources based on said predicted actions and based on predicted costs associated with said predicted actions such that computing resources for said software application are made available dynamically based on learned patterns of the user's actions.

In certain aspects the software activates computing resources of the IaaS environment based on said predicted actions prior to said predicted actions occurring. In other aspects the software determines the predicted actions through a user interface monitoring function which monitors interaction by the plurality of users with a user interface of the software application to identify one or more patterns in order to determine one or more of the predicted actions. In still other aspect the software accesses data indicative of historical patterns of user interaction with the user interface and the software correlates the interaction by the plurality of users with one or more of the historical patterns to indicate one or more of the predicted actions. In yet further aspects a user interface monitoring function monitors interaction by the plurality of users with a user interface of the software application to identify one or more patterns, wherein said software identifies one or more computing tasks of the software application associated with the one or more patterns and associates the one or more patterns with the identified one or more computing tasks as data in a storage accessible to the software application. In further aspects the user interface monitoring function compares interaction by the plurality of users to the data in the storage to correlate one or more monitored patterns of said interaction by the plurality of users the one or more patterns associated with said data in order to identify the one or more predicted actions of the user. In still other aspects the software activates and/or deactivates computing resources such that one or more tasks of the software application are executed by different IaaS service providers. In yet further aspects the software monitors use of said software application following a change in availability of computing resources to determine an actual change in computing resource need as compared to a predicted change in computing resource need based on the predicted actions to modify how future predicted change in computing resources result in activation and/or deactivation of computing resources. In yet other aspects the predicted actions are selected from a group consisting of: running a report, uploading one or more files, running a telecommunications usage report, running a telecommunications device inventory report, running a sales lead report, running a contact data report, data entry, running an audit report and combinations thereof.

Other objects are achieved by providing a system for modifying availability of cloud computing resources based on predicted needs. The system includes software executing on a computer, the software is in communication with a software application accessible to a plurality of users. The software application is configured to execute computing resources of a computing service provider wherein computing resources available for execution of said software application are adjustable to activate and/or deactivate reservations of computing resources which are available to the software application. The software determines predicted actions of the user within the software application and the software determines predicted costs associated with the predicted actions. Based on the predicted costs and predicted actions, the software adjusts the reservations of computing resources with the computing service provider for the software application;

In certain aspects the predicted actions are determined based on monitoring use of the software application by the plurality of users to identify one or more patterns and correlating at least one of the one or more patterns to historical usage information associated with the software application. In other aspects, the software includes a user interface monitoring function which monitors interaction by the plurality of users with a user interface of the software application to identify one or more of the patterns in order to determine one or more of the predicted actions. In still other aspects the activation and/or deactivation of computing resources software activates and/or deactivates computing resources from different Infrastructure as a Service (IaaS) providers. In still other aspects the user interface monitoring function compares interaction by the plurality of users to the data in a storage to correlate one or more monitored patterns of said interaction by the plurality of users the one or more patterns associated with said data in order to identify the one or more predicted actions of the plurality of users.

Other objects are achieved by providing a system for instantiating cloud services including software executing on a selected one or more computing resources of a plurality of computing resources. The software provides a user interface for providing software as a service to a plurality of users. The software further determines one or more predicted actions of one or more of the users with said user interface which requires use of the selected one or more computing resources and the software activates and/or deactivates one or more of the plurality of computing resources to add or remove those activated and/or deactivated resources from the selected one or more computing resources based on said predicted actions and based on predicted costs associated with said predicted actions such that computing resources for said software are made available dynamically based on learned patterns of the user's actions.

In certain aspects the software includes a user interface monitoring function which monitors interaction by the plurality of users with the user interface to identify one or more of patterns of the plurality of users in order to determine one or more of the predicted actions. In yet other aspects the predicted actions are determined based on monitoring use of the software by the plurality of users to identify one or more patterns and correlating at least one of the one or more patterns to historical usage information associated with the software. In still other aspects the software monitors use by the plurality of users a change in availability of computing resources to determine an actual change in computing resource need as compared to a predicted change in computing resource need based on the predicted actions to modify how future predicted change in computing resources result in activation and/or deactivation of computing resources. In yet other aspects the activated and/or deactivated one or more of the plurality of computing resources are provided by different Infrastructure as a Service (IaaS) providers such that one or more tasks of the software are performed by computing resources provided by the different IaaS providers.

Other objects of the invention and its features and advantages will become more apparent from consideration of the following drawings and accompanying detailed description.

### BRIEF DESCRIPTION OF THE DRAWINGS

FIGS. 1A and 1B are component overviews of the system.

FIG. 2 is a Context Diagram of various system components.

FIG. 3 Depicts the Logical Process overview.

FIG. 4 Depicts the Logical Process within a user session.

FIG. 5 is a detailed view of the resource management and reservation system.

FIG. 6A Shows how usage history per user is accessed and updated.

FIG. 6B shows an example of the table for FIG. 6A.

### DETAILED DESCRIPTION OF THE INVENTION

Referring now to the drawings, wherein like reference numerals designate corresponding structure throughout the views.

The following examples are presented to further illustrate and explain the present invention and should not be taken as limiting in any regard.

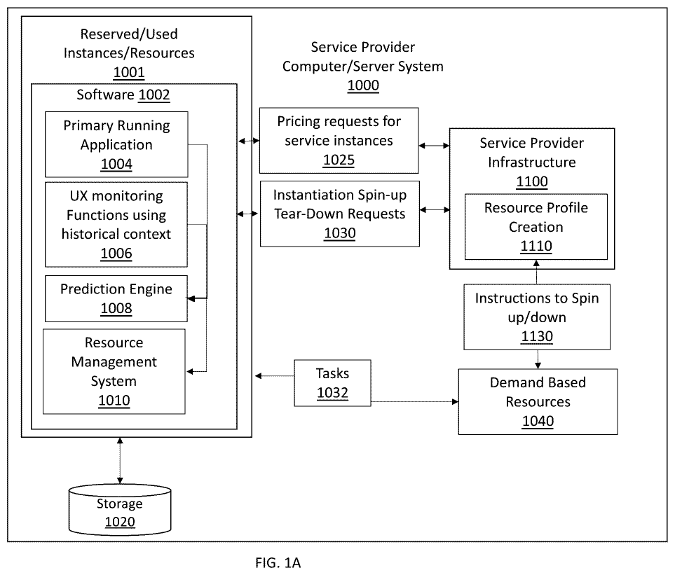

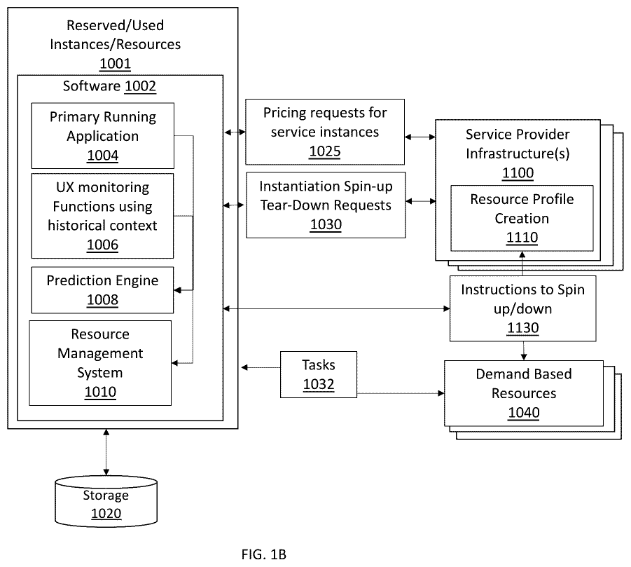

Referring to FIG. 1A, the service provider computer/server system computer 1000 includes software 1002 executing thereon and is connected to storage 1020. Within the software 1002 reside multiple modules including the primary running application 1004 and will typically reside on the reserved/used instances 1001 and/or virtualized machines made available by the IaaS provider, user interface and experience or UX monitoring function using historical context 1006, a prediction engine 1008, and a resource management system 1010. The primary application 1004 represents the application that the users are using to perform various functions, the example of CRM software is explained below as but one possible option. With this application running, user interface monitoring 1006 is employed to monitor what various users are doing within application 1004. Thus, the user interface monitoring 1006 software tracks user interactions with features of the application 1004 including highlighting, selections, modifications, data inputs and various other features. Particularly, as a user moves the mouse/cursor towards particular locations/areas on the application 1004, the system may begin to predict that resources needed to process the requests that are associated with a particular area of the application 1004 may be needed. Thus, the prediction engine 1008 will receive data from the US monitoring 1006 and the particular locations the user is moving towards and clicking along with other interactions the user makes when performing various tasks. The prediction engine 1008 will begin to learn with respect to each user what patterns they engage with in terms of UX interaction so that when a similar pattern happens in the future, the prediction engine 1008 can compare the current pattern to historical data patterns to predict what the user will do, e.g. clicking a particular button on the user interface that will cause computing resources to be used. Thus, as the prediction engine 1008 identifies what the user interaction is likely to be based on UX monitoring 1006. The prediction engine 1008 may, for example, obtain various forms of data from the storage 1020 or directly from the IaaS provider 1100. The resource management system 1010 can then use the predictions from the predictions engine 1008 in combination with pricing information 1025 and information on already previsioned resources 1040 to determine what spin-up and/or tear down requests 1030 are warranted.

FIG. 1B shows a system similar to FIG. 1A but instead of a single provider 1000 for the overall architecture, the reserved instances 1001 may be provided by one server/provider whereas specific tasks 1032 may be accomplished by demand based resources 1040 from one or more different providers (which may include the provider of the reserved instances 1001). Therefore, in the implementation of FIG. 1B, the system enables the pricing requests/information 1025 to be compared for various different instances (this information may also be kept in storage 1020 and then given that the prediction engine 1008 has predicted specific tasks or activities within the primary application 1004, the system can know or also predict what resources will be required for each task/activity based on historical information concerning similar tasks/activities or prior running of those same tasks/activities. With this predicted resource need and the pricing of multiple providers, the resource management system software 1010 can implement and reserve demand based resources 1040 in a manner that minimizes or reduces costs. For example, one provider may charge more for bandwidth and less for processing and a different provider may be the reverse. Thus, high bandwidth tasks should go with the second provider whereas low bandwidth and high processing tasks should go with the first. The various activities/tasks within the application 1004 can be segregated by provided in a more cost efficient or optimized way to reduce overall costs of running the software 1004. Since the tasks are predicted in advance of the tasks 1032 actually being implemented, the spin up/tear down 1030 can be accomplished before the tasks 1032 are implemented such that when implemented.

The prediction engine 1008 when predicting what a user will do can also have historical knowledge in the form of data in the storage 1020 which data can indicate what mixture and type of computing power will be required by the predicted task(s). The storage 1020 may contain or the software 1002 may access cost data which cost data indicates the cost of various computing tasks such as bandwidth, processing, storage etc available from a variety of IaaS providers. Thus, the demand based resources 1040 may be selected based on which provider has the better cost structure for a given task, thus allowing the software application 1004 to use IaaS resources from different providers for various tasks.

The software 1002 running on the computer 1001 sends requests for pricing 1025 with specified resources needed to one or more service providers 1100. After selecting the most cost-effective solution, the software 1002 issues requests 1030 to spin up or tear down instances of cloud computing from the selected service provider 110. To describe the resources, a resource profile creation 1110 is used, and the demand based resources 1040 are made available to the software 1002 via instructions to spin up/down resources 1130 (if not used, the instructions could spin down). Then, demand based tasks 1032 can be accomplished by these demand based resources 1040.

Although the SaaS application 1004 is shown as part of the software 1002 which monitors the overall system, the SaaS application and the software which performs the monitoring 1006 and prediction 1008 and resource management 1010 may execute on separate computers/resources. Thus, although FIGS. 1A and B show the various applications/functions 1004, 1006, 1008, 1010 and the software 1002 as executing on one computer/instance 1001, these all may be distributed on different instances/computers or combinations of the same and different instances/computers which are in communication via a network connection. For simplicity, each iteration/combination is not shown, but would be understood to those of skill in the art.

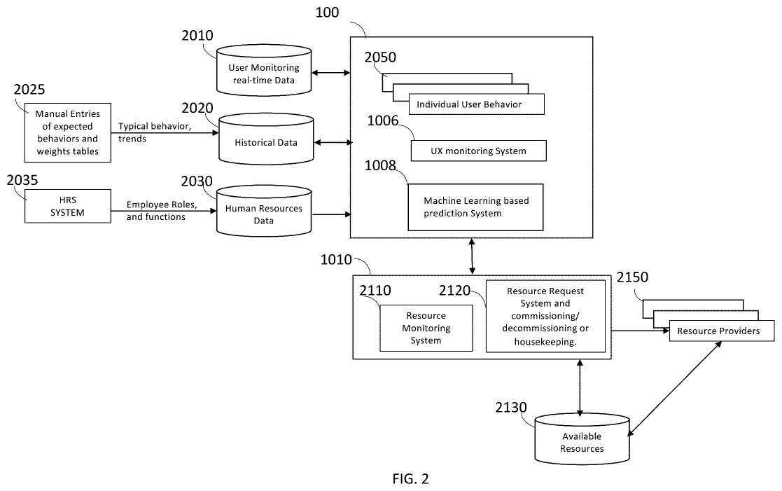

Turning now to FIG. 2 we see the main application 1004 where users are running their tasks. Consider an example of a CRM (customer relationship management) system where the main application 2000 runs the services provided by such a CRM. Individual user behaviors (2050) are monitored by a UX monitoring system 2060 and stored in a user monitoring real time database 2010. Again, with the CRM example, users may be running reports, entering new leads, estimating commissions, or answering questions on the system.

Included in the main application system is also a machine learning based prediction system 2070 which learns from past behavior and contextual information obtained from historical data 2020. Further, manual data 2025 including weight tables to determine predictions can be entered. While these form the initial baseline, the machine learned prediction system 2070 can adjust these values based on its experience with the user groups using the system 2050.

Further, HRS (Human Resources Systems) 2035 contains important contextual information used as input to a human resources database used by the system. This includes the roles and functions of employees. For example, a salesman may have certain functions withing the CRM system which can aid the system in formulating predictions.

With the predictions made, the system software 1002 interacts with a resource management system 1010 which includes resource monitoring 2110 of the existing system resources available to a given user, and all users. This resource management system 1010 also manages the requests for resources 2120 from a number of service providers 2150 which can provide these resources into the available resources pool 2130. This resource management system function 2120 also decommissions the resources when they are no longer needed and does periodic housekeeping and garbage collection freeing up resources and instances that are no longer needed by the system (2000).

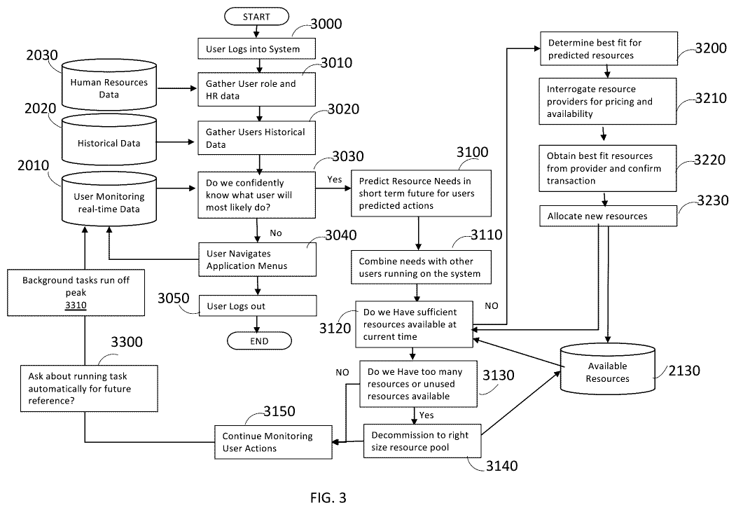

Turning now to FIG. 3, we see a Logical Process overview of the system. When a user first logs into the system 3000 the system gathers HR data 3010 from the HR database 2030. The system then gathers historical data 3020 from the historical database 2020 and performs user monitoring.

In some cases, a user may always login and do the same thing. Even without extensive user monitoring, the system may decide it is able to make an accurate prediction. In other cases, more extensive monitoring is required, and the system will track the user interface and users' interactions with the application.

Once the system can confidently assess 3030 what the user will do, it will predict the resource needs 3100 for the anticipated actions. The system will combine the resource needs with other users on the system 3110 to obtain a consolidated view of resource requirements and will check existing resources 3120 which may exist in the available resources pool 2130. If insufficient resources are available, the system will determine the best fit 3200 of resource providers and resource types for the required function which have been predicted previously. This is done by interrogating 3210 service providers for the type of resources needed and confirming the transaction 3220 and finally allocating the resource 3230 upon which time they become part of the available resources pool.

If sufficient resources exist 3120 the available resources are pulled from the pool of available resources 2130 and allocated to the task in expectation of the predicted needs.

The system also checks if there are too many resources 3130 in the pool 2130 and will decommission 3140 to right size the pool 2130. This can be a result of resources being committed and the user prediction did not come true, or in some cases when the resource demands are high for similar types of resources, such as many people doing the same functions, the system may decide to leave resources in the pool 2130 longer in anticipation of future needs.

After obtaining and allocating new resources 3230 or reserving existing resources from the pool 2130, the system continues to monitor the user actions 3150 and updates the user monitoring real time data 2010 with what is observed from the user's behavior and interactions with the system.

If reports are typically run, the system also asks the user 3300 if they would like to have the report delivered automatically. This allows the system to leverage running the tasks in off-peak times to save additional cost. If so, the tasks is placed in a list of 3310 tasks to be run off-peak.

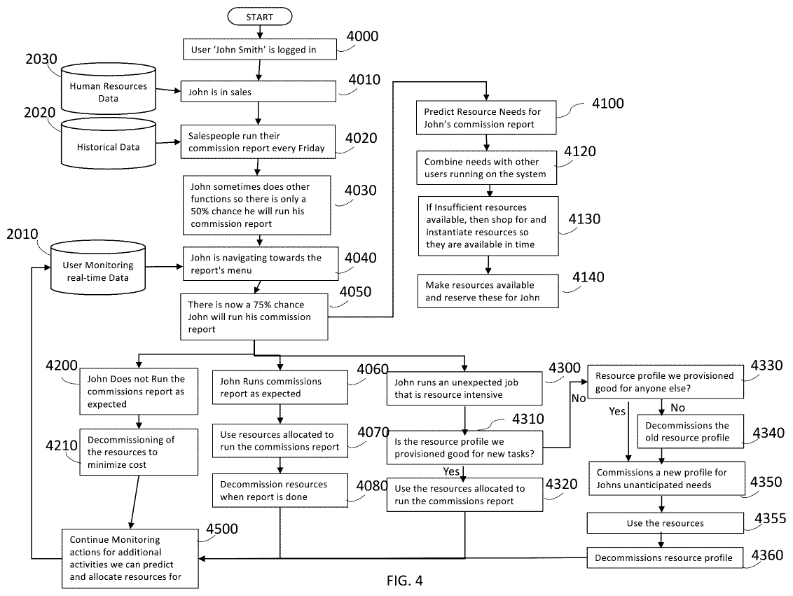

Turning now to FIG. 4, we see the Logical Process within an example user session.

For this example, John Smith logs in 4000 and the system determined from the HR data 2030 that John is in sales 4010. From historical data 2020, the system knows that salespeople run their commission report every Friday 4020 and, being Friday there is a good chance John will be running this report.

John however from the historical data 2020 is also known to also do additional functions 4030 reducing the likelihood of the commissions report being run immediately by 50%. The system continues to monitor John's movement within the system 2010 and sees that Jon is navigating towards the reports menu 4040. The system now determines that there is a 75% change 4050 that John will be running the commission report.

The system then predicts the resources needed to allocate compute requirements for the commissions report 4100 and combines these with the predicted needs and actual needs of other users in the system 4120. It then checks if sufficient resources are available, and if not, it shops for and obtains such resources and allocates them so they are available and reserved for John 4104 for the prediction.

Three possible scenarios are depicted whereby in the first case, John does not run the commissions report 4200 as expected. Here, the resources are decommissioned 4210 to minimize cost. It should be noted that in some cases, the system may decide to override the decommissioning request to keep the resources on hand longer if there is a likelihood that someone else may require such resources in the near future.

The second scenario is that John runs the commissions report as expected 4060 and in this case the resources were pre-allocated 4070 for the predicted tasks and they are used accordingly. While there may be some timing variances regarding how quickly John runs the report and how soon the resources are available, this variance is generally not perceptible as John simply pushes the button for the report and soon after the report runs. When the report is done, the resources are decommissioned 4080.

The third scenario is one where John runs an unexpected job 4300 instead of the commissions report predicted. In such a case, the system evaluates using the pre-allocated resources for the new tasks and if so, they are used accordingly 4320. If not, 4330 the system looks to see if another system user has a need for such a profile and decommissions 4340 the resources if not. Either way, new resources must be provisioned for the unexpected task 4350 and once they are used 4355 the system requests decommissioning 4360 of the resources. Again, the system may override the decommissioning if other users on the system have anticipated needs.

Even in cases where resources remain on the system unused, a garbage collection process freeing up these resources is performed when reservations have become stale.

After each of the three scenarios described above 4200 4060 and 4300, the system continues monitoring 4500 of the user behavior and updates the real time user monitoring data 2010 to improve predictions in future for this user and to continue anticipating John Smith's computing needs while he remains logged into this session.

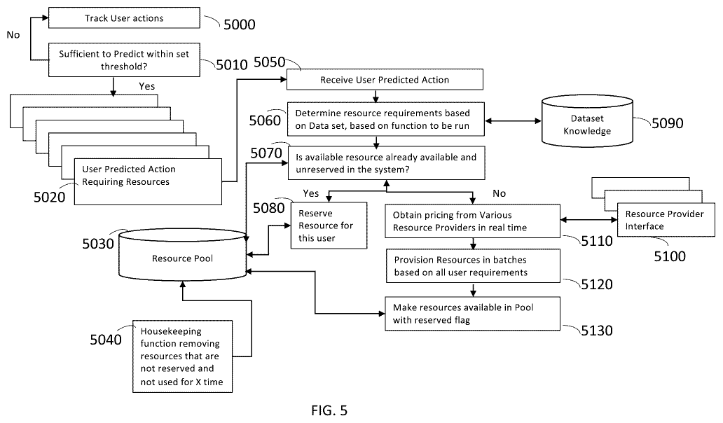

Turning now to FIG. 5 we see a more detailed view of the resource management and reservation system. User actions are tracked 5000 and a determination is made 5010 on whether a prediction can be made with a degree of confidence sufficient to allocate resources. These user predictions 5020 are gathered from each user on the system.

The system takes each request 5050 and determined the resource requirements 5060. A dynamic dataset knowledge 5090 is used to determine resource requirements. One reason for this is the continual changes in the data set used by the system. If, for example, last month 1 million clients were in the system it would take a certain resource profile to run a detailed report. If this month, an additional 1 million users have been added, the resources needed to run the report for 2 million users may be different.

The system checks the available resources on the system that have already been allocated (5070 and if these exist 5080 it places a reservation on them in the resource pool 5030 for the user in question. If they do not exist, the system obtains pricing 5110 from various resource providers 5100 and provisions the resources in batches 5120 based on all the users' requirements at any given time. Once the resources are available, they are placed 5130 in the resource pool 5030 and reserved for the users in question.

Periodic housekeeping tasks 5040 are run to remove reserved resources after a predetermined timeframe. This timeframe may vary based on system load and total number of users.

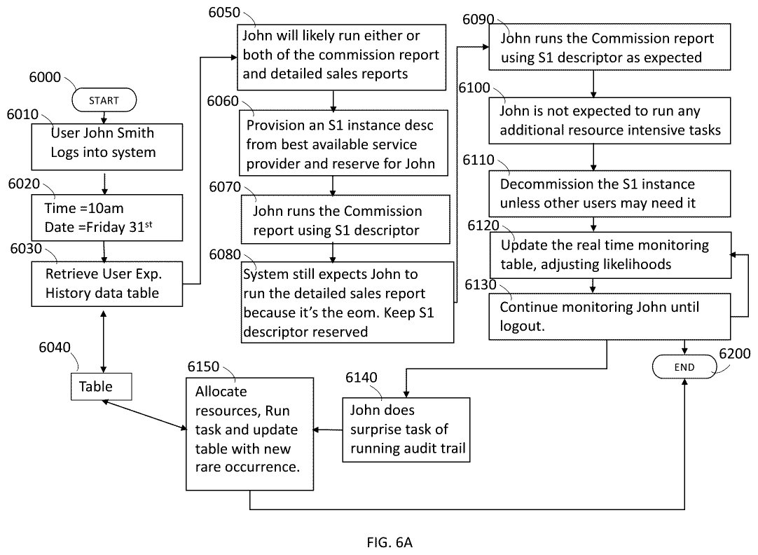

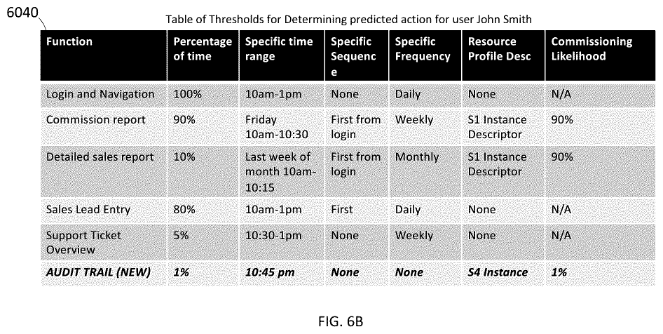

Turning now to FIGS. 6A and B, we see a sample User Experience table made for user John Smith in the examples above.

Starting 6000 the system detects John Smith logging in 6010 and checks that the date 6020 is a Friday at the end of the month and 10 am. After retrieving 6030 the historical data 6040 for John Smith the system sees that based on the date and time, John is likely to run both the commissions report line 2 in the table 6040 as well as the detailed sales report which is line 4 in the table 6040. For both lines, the system sees in column 6 that an S1 instance is required. Column 7 shows that there is a 90% likelihood based on historical data that John will run these reports 6050.

The system then provisions an S1 instance 6060 from the best available provider in anticipation of John running these reports. The timing is adjusted to the specific sequence john usually runs this report which is shown in column 4 of the table 6040 and in this case shown as first thing done after login. John turns the commissions report 6070 and the S1 descriptor provisioned and reserved for John is used. Based on the information in the table 6040 John is still likely to run the detailed sales report, so the S1 descriptor is not decommissioned or released for other users, instead it is kept reserved for John 6080.

John does in fact run the detailed sales report 6090 and the S1 instance is utilized to run the report. After this time, the system does not expect John to run any additional compute intensive tasks 6100 so the system decommissions the instance 6110 and updates the real time monitoring 6120 in table 6040. In this case, the percentages are increased in column 2 as John did what was expected. The system continued to monitor 6130 John's actions until log out 6200.

Assume for a minute that John was to introduce a new action surprising the system, and instead of logging out as expected 6200 John instead introduced a new resource intensive operation running an audit report 6140. The system knows how to run an audit report and knows an S4 resource profile is required. The system allocated the resource profile and runs the report for John. Since it was unexpected, the response time is longer than usual, but the report is run. The system also updates table 6040 with a new line, line 6 shown in bold introducing the new task. Since it is the first time John has run 6140 the task, the system allocates a very small percentage to the likelihood of John running this task. That said, the system can monitor Johns actions and if it seems John advancing towards the menus where the audit trail can be run, this likelihood increases, and the system may spawn an S4 tasks in anticipation of John's actions. This is an example of the machine learning capabilities within the system for tracking John and adjusting the table dynamically. If John never runs the report again, and the likelihood is decreased below a given threshold, the system may also remove line 6 from table 6040 and consider it a one-of occurrence and not plan to reserve resources for such an occurrence again.

In the general course of running the application, only a minimal set of resources needs to be provisioned in order to run a few users. As the user load grows, and when peak resource demands are being imposed, new cloud instances are fired up to scale the application. On a somewhat exaggerated scale consider each time someone wants to run a report on our system, we simply (a) bid on lowest cost cloud time out there with estimated usage profile (b) spin up the instance (c) get our result (d) tear it down (unless someone else is waiting and it would be cheaper to keep it on for a while.

With the system and its software knowing the application and its functionality, the system is able to anticipate the required resources for a given function. Further, even as the application and the data set scale over time, the machine learning aspect of the system is able to accurately scale and estimate these resource demands to match the scaling of the dataset.

When multiple users are accessing the system, the predictive capabilities extend further to having multiple instances that can be shared and kept running even when jobs are completed if it is predicted that other users would run the same jobs. These tasks are kept within a resource reservation system with a time limit set for reservations. Unreserved tasks remain available for reservations to be made for an extended period after which housekeeping systems doing garbage collection free them up and decommission them.

Rather than maintain sufficient bandwidth to process jobs in a timely manner and only spin up additional capacity when queues get long and user experience is reduced with delays, the systems prediction capability gives it a better lead time leading to improved user experience.

For example, when the sales manager logs into the system at the end of the day the system knows that he runs a daily report of sales related activities. As soon as the login is detected the system may predict this behavior and spin up the resources required to run the job. In some cases where data is static (for example he runs the report at the end of the day when salespeople have left, and no new orders are being entered) the report can already be generated in anticipation of him wanting to run it with a high level of confidence.

When the system is first deployed, it tracks user activities to create a baseline of user behavior and uses this to predict. As more data is collected and users behaviors monitored and mapped, the predictions become more accurate.

Take for example, the initial deployment of the system. Each user that logs in may generate a new task capable of running the most resource intensive tasks that the system has, and this job may be active for as long as the user is logged in. This is an extremely conservative case and used for illustration purposes only. In reality, it would be surprising if for each 100 users logged into a system, more than a few resource intensive tasks were running at any given time. Statistically, ½ dozen shared resources may suffice.

To continue with the illustration, take one user in particular who logs in and runs a simple report. Say this user has logged in 2 or 3 times now and always just viewed some simple screens and run this low resource report. The next time this same user logs in, the system will have learned to only provision a smaller resource profile for this user.

Continuing with this example, one day, after many logins the user runs a much more intensive report. The system may correlate additional aspects such as date and time, and hypothesize that being a Friday, the user may be running a higher intensity report. In future logins, the system will still provision the smaller resource profile for this user when he logs in but if the system detects the user moving towards a more intensive area of the application it may pre-provision additional resources in anticipation of the user running the new intensive report. If it's deemed that the running of the report can be correlated to Friday, the system will start provisioning a larger resource profile for Friday logins.

Take now the case of a new user to the application. The system detects from the HR (human resources) systems that the user is part of the support team, and thus the system may provision the typical support function profile which has been learned from other support personnel's behavior that utilize the system. This resource profile forms the starting point for the user and the system will tailor this as is needed for the given user.

The system also allocates a number of distinct resource profiles that can accommodate one or more demands using the same profile. This simplifies provisioning, price shopping, and reuse. As the system expands and additional functions are added, it may also decide to split one group or category of resource profiles into two to further optimize costs.

Continuing with the example, consider now that there are 100 users in various categories, the system detects that there are now 25 salespeople logged into the system and in a typical login, the users will run intensive commissions reports when they login. The system may pre-provision 3 jobs for running such reports, each of which may take a minute to run. If all 3 of the jobs are running for users, and the system again sees a 4^{th} user approaching the report area of the application, a new job profile is provisioned in anticipation of having a pool of resources available to run the tasks demanded by the 25 logged in salespeople at any given time. If the resources remain unused beyond a certain threshold time, a house cleaning operation removes and decommissions them. Should the user log out of the system, the system will also automatically decommission them, or leave them for the housekeeping to handle in case there are new users logging in that might need and use them.

It may guess wrong and have the wrong resources spun up, but this is also part of the learning process. The system gets faster over time as it learns. It will also improve on the accuracy of the resources needed as it learns further thereby reducing costs.

Given enough time, the system can ‘shop around’ for the most economical solution for the given task within a provider or even across providers. It may also leverage volume discounts with one or more providers for mutual benefit.

Although the invention has been described with reference to a particular arrangement of parts, features, and the like, these are not intended to exhaust all possible arrangements or features, and indeed many other modifications and variations will be ascertainable to those of skill in the art.

What is claimed is:

1. A system for instantiating cloud services in an infrastructure as a service (IaaS) environment comprising:
software executing on a computer, said software in communication with a software application accessible to a user, said software determines one or more predicted actions of the user within said software application and activates and/or deactivates computing resources based on said predicted actions and based on predicted costs associated with said predicted actions such that computing resources for said software application are made available dynamically based on learned patterns of the user's actions.

2. The system of claim 1 wherein said software activates computing resources of the IaaS environment based on said predicted actions prior to said predicted actions occurring.

3. The system of claim 1 wherein said software determines the predicted actions through a user interface monitoring function which monitors interaction by the plurality of users with a user interface of the software application to identify one or more patterns in order to determine one or more of the predicted actions.

4. The system of claim 3 wherein said software accesses data indicative of historical patterns of user interaction with the user interface and the software correlates the interaction by the plurality of users with one or more of the historical patterns to indicate one or more of the predicted actions.

5. The system of claim 3 further comprising a user interface monitoring function which monitors interaction by the plurality of users with a user interface of the software application to identify one or more patterns, wherein said software identifies one or more computing tasks of the software application associated with the one or more patterns and associates the one or more patterns with the identified one or more computing tasks as data in a storage accessible to the software application.

6. The system of claim 5 wherein said user interface monitoring function compares interaction by the plurality of users to the data in the storage to correlate one or more monitored patterns of said interaction by the plurality of users the one or more patterns associated with said data in order to identify the one or more predicted actions of the user.

7. The system of claim 1 wherein said software activates and/or deactivates computing resources such that one or more tasks of the software application are executed by different IaaS service providers.

8. The system of claim 1 wherein said software monitors use of said software application following a change in availability of computing resources to determine an actual change in computing resource need as compared to a predicted change in computing resource need based on the predicted actions to modify how future predicted change in computing resources result in activation and/or deactivation of computing resources.

9. The system of claim 1 wherein the predicted actions are selected from a group consisting of: running a report, uploading one or more files, running a telecommunications usage report, running a telecommunications device inventory report, running a sales lead report, running a contact data report, data entry, running an audit report and combinations thereof.

10. A system for modifying availability of cloud computing resources based on predicted needs comprising:
software executing on a computer, said software in communication with a software application accessible to a plurality of users, said software application configured to execute computing resources of a computing service provider wherein computing resources available for execution of said software application are adjustable to activate and/or deactivate reservations of computing resources which are available to the software application;
said software determines predicted actions of the user within said software application;
said software determines predicted costs associated with said predicted actions;
based on said predicted costs and predicted actions, said software adjusts the reservations of computing resources with the computing service provider for said software application;

11. The system of claim 10 wherein the predicted actions are determined based on monitoring use of the software application by the plurality of users to identify one or more patterns and correlating at least one of the one or more patterns to historical usage information associated with the software application.

12. The system of claim 11 wherein said software includes a user interface monitoring function which monitors interaction by the plurality of users with a user interface of the software application to identify one or more of the patterns in order to determine one or more of the predicted actions.

13. The system of claim 11 wherein said activation and/or deactivation of computing resources software activates and/or deactivates computing resources from different Infrastructure as a Service (IaaS) providers.

14. The system of claim 12 wherein said user interface monitoring function compares interaction by the plurality of users to the data in a storage to correlate one or more monitored patterns of said interaction by the plurality of users the one or more patterns associated with said data in order to identify the one or more predicted actions of the plurality of users.

15. A system for instantiating cloud services comprising:
software executing on a selected one or more computing resources of a plurality of computing resources, said software providing a user interface for providing software as a service to a plurality of users, said software further determining one or more predicted actions of one or more of the users with said user interface which requires use of the selected one or more computing resources and said software activates and/or deactivates one or more of the plurality of computing resources to add or remove those activated and/or deactivated resources from the selected one or more computing resources based on said predicted actions and based on predicted costs associated with said predicted actions such that computing resources for said software are made available dynamically based on learned patterns of the user's actions.

16. The system of claim 15 wherein said software includes a user interface monitoring function which monitors interaction by the plurality of users with the user interface to identify one or more of patterns of the plurality of users in order to determine one or more of the predicted actions.

17. The system of claim 15 wherein the predicted actions are determined based on monitoring use of the software by the plurality of users to identify one or more patterns and correlating at least one of the one or more patterns to historical usage information associated with the software.

18. The system of claim 15 wherein said software monitors use by the plurality of users a change in availability of computing resources to determine an actual change in computing resource need as compared to a predicted change in computing resource need based on the predicted actions to modify how future predicted change in computing resources result in activation and/or deactivation of computing resources.

19. The system of claim 1 wherein said activated and/or deactivated one or more of the plurality of computing resources are provided by different Infrastructure as a Service (IaaS) providers such that one or more tasks of the software are performed by computing resources provided by the different IaaS providers.
